(19) United States
(12) Patent Application Publication
(10) Pub. No.: US 2009/0152817 A1
(43) Pub. Date: Jun. 18, 2009

(54) ENERGIZED DYNAMIC SEAL USED IN OIL WELL EQUIPMENT

(75) Inventor: Michael H. Du, Pearland, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/957,093

(22) Filed: Dec. 14, 2007

(51) Int. Cl. F16J 15/02; F16J 15/38

(52) U.S. Cl. 277/315; 277/399

(57) ABSTRACT

A seal assembly usable with a well includes a seal ring that is adapted to expand radially inwardly and radially outwardly in response to being longitudinally compressed between a first energizing ring and a second energizing ring. The seal assembly may also include a first backup ring between the seal ring and the first energizing ring and a second backup ring between the seal ring and the second energizing ring.

### BACKGROUND

The invention generally relates to forming seals used in a well.

Polymer seals, which include elastomer and plastic seals, are commonly used in downhole tools. Polymer seals are often used due to their flexibility, resilience and their ability to seal uneven or irregular surfaces. However, for some downhole environments, such as environments that present extremely high temperatures and high pressures (as examples), conventional polymer materials may not be suitable. Furthermore, even in applications in which polymer seals may be used, material degradation, failure and property variations due to environmental changes may make the use of polymer seals challenging. A backup system typically is used with a polymer seal due to the seal's poor anti-extrusion resistance.

A bonded seal may be used in a downhole application in place of a polymer seal. A bonded seal is a dynamic seal that has an elastomer seal element bonded onto a reinforcing structure. Bonded seals provide for a very economical and reliable sealing interface in certain dynamic working conditions and environments.

The performance of bonded seals typically depends on the elastomer and reinforcing materials used. However, while seeking a breakthrough in materials for high pressure high performance (HPHT) environments, there are other mechanical and physical properties of the bonded seal which may maximize and enhance the seal performance of materials used in downhole tools. There are several factors which may affect seal performance, for example, the size of the seal (squeeze in) when the seal is stabbed into the seal bore, the mechanism for preventing the elastomer extrusion of the seal, and the strength of the reinforcing structure.

Since the current bonded seals have an oversized seal element, it is difficult to stab the seal into the seal bore because the outer diameter of the seal element is larger than the diameter of the bore. Therefore, damage may be caused to the seal elements during the stab-in process. When temperature is high, the mechanical properties of the elastomer degrade significantly, which makes the seal element even more vulnerable. Therefore, stab-in tests are usually required in the qualification procedures for a bonded seal. Also, for the high pressure high temperature conditions, bonded seals generally do not have an effective extrusion preventing mechanism. Furthermore, due to the limitation of the available space, the reinforcing structures in bonded seals are not strong enough to maintain the load from high pressure environments.

### SUMMARY

In an embodiment of the invention, a seal assembly which is usable with a well includes a seal ring that is adapted to expand radially inwardly and radially outwardly in response to being longitudinally compressed between a first energizing member and a second energizing member. The seal assembly may also include a first backup member between the seal ring and the first energizing member and a second backup member between the seal ring and the second energizing member.

Advantages and other features of the invention will become apparent from the following drawing, description and claims.

### BRIEF DESCRIPTION OF THE DRAWINGS

FIG. 1 depicts a perspective view of a seal assembly according to an embodiment of the invention.

FIG. 2A is a partial perspective view of the seal ring of FIG. 1 according to an embodiment of the invention.

FIG. 2B is a partial perspective of the seal assembly of FIG. 1 after the seal ring is energized according to an embodiment of the invention.

FIG. 3 is a schematic diagram depicting the seal assembly before the seal ring is energized according to embodiments of the invention.

FIG. 4 is a schematic diagram depicting the seal assembly after the seal ring is energized according to embodiments of the invention.

FIG. 5 depicts a partial perspective view of an energized seat assembly having backup members according to another embodiment of the invention.

FIG. 6 is a schematic diagram depicting the energized seal assembly having backup members of FIG. 5 according to embodiments of the invention.

FIG. 7 is a schematic diagram depicting the seal assembly before the seal ring is energized and a snap ring according to embodiments of the invention.

FIG. 8 is a schematic diagram depicting the seat assembly after the seal ring is energized and the snap ring is locked according to embodiments of the invention.

FIG. 9 is a schematic diagram depicting the seal assembly having backup members after the seal ring is energized and a snap ring according to embodiments of the invention.

FIG. 10 is a partial side view of a seal ring assembly according to another embodiment of the invention.

### DETAILED DESCRIPTION

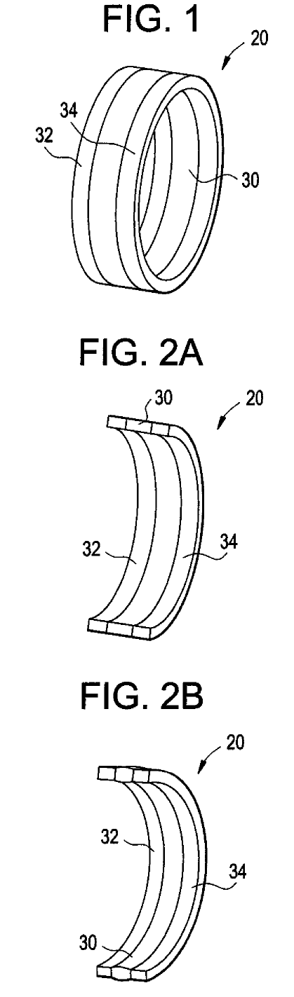

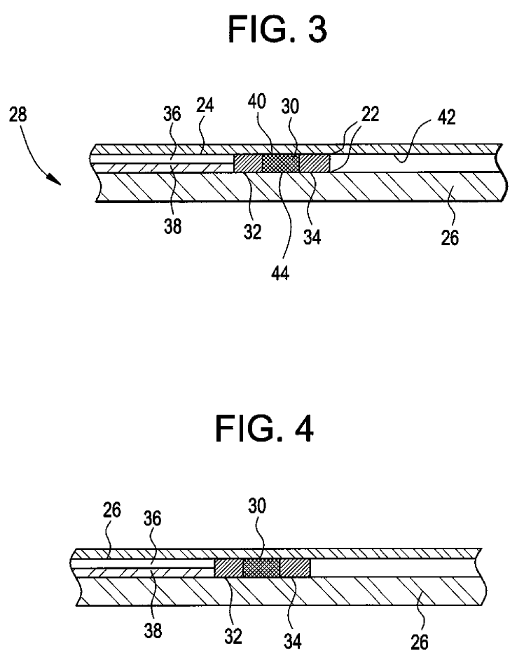

Referring to FIG. 1, a seal assembly 20 in accordance with embodiments of the invention may be used to form a seal 22 between an inner tubular member and an outer tubular member in a well 28. As an example shown in FIG. 3, the outer tubular member may be a housing 24 of a well, and the inner tubular member may be mandrel 26, although the tubular members may be different components in other embodiments of the invention. For example, it is understood that the inner member may be a solid component like a piston. Both tubular members and are generally concentric with and generally extend along a longitudinal axis of the well. In general the seal assembly 20 includes a cylindrical seal ring 30, which has a thickness profile and other geometrical features that cause the seal ring to expand both radially inwardly and radially outwardly when longitudinally compressed to form the seal between the tubular members.

As depicted in FIGS. 1 and 2A, the seal assembly 20 comprises a seal ring 30 between a first energizing member 32 and a second energizing member 34. The seal ring 30 is shown in a state before the seal ring 30 is energized and is adapted to expand radially inwardly and radially outwardly in response to being longitudinally compressed between the first energizing member 32 and the second energizing member 34 so that sealing is on both the inner and outer surfaces of the bore 36. Since the seal ring 30 assembly is not significantly oversized like the seal ring assembly in a regular bonded seal assembly, the process of stabbing the seal assembly into a bore is easier because there is no significant squeeze in. Also, there is no damage to the seal assembly because an outer diameter 40 of the seal assembly is smaller, or only slightly larger, than a diameter 42 of the bore.

The seal ring 30 may be made of an elastomer material or any suitable material that seals and may be compressed. The seal ring may have different dimensions, in accordance with other embodiments of the invention, which are selected for performing different functions. The seal ring may also have a variety of different cross-sectional shapes for achieving relatively high contact stress and better sealing performance. The first energizing member and the second energizing member may be in the form of a ring and made of a metal material. However, it is understood that any material hard enough to compress the seal ring but not significantly deform under force may be used. For example, as shown in FIG. 10, another embodiment of the seal assembly includes the seal ring 30 which may be compressed between the energizing member 32 in the form of a ring on one side of the seal ring and an end of a body, such as a solid component 33, on the other side of the seal ring.

Once the seal assembly 20 is stabbed into the bore 36, the seal ring 30 may be energized, or compressed, by applying an axial load on the first energizing member 32 via a sleeve 38, as shown in FIG. 2B. After the seal ring 30 is energized, the seal ring 30 may expand along a radial direction to form a sealed interface between an outer diameter 40 of the seal ring 30 and the housing 24 (seal bore). Additionally, a second sealed interface may be provided between an inner diameter 44 of the seal ring 30 and the mandrel 26 (seal piston). The seal ring may be undersized, or just slightly larger than the bore, so that the seal ring may be stabbed into the bore easily and safely during high pressure high temperature conditions.

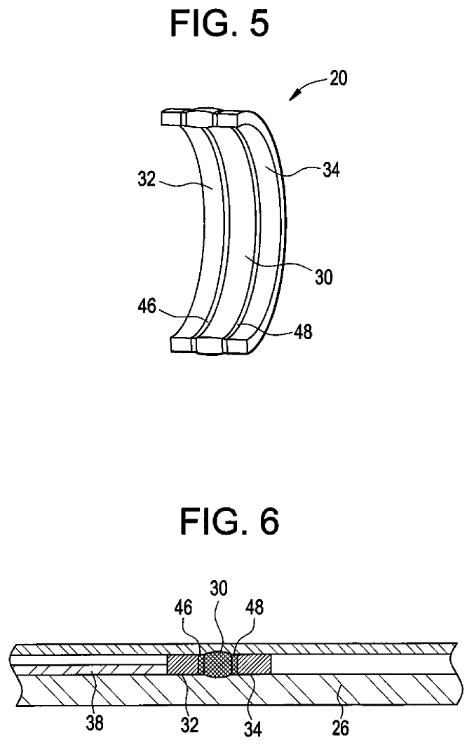

In another embodiment the seal assembly may include at least one back up member for enhancing the sealing performance of the seal assembly. As shown in FIG. 5, the seal assembly 20 may include a first backup member 46 between the seal ring 30 and the first energizing member 32. Also, the seal assembly may include a second backup member 48 between the seal ring 30 and the second energizing member 34. The first backup member 46 and/or the second backup member 48 may be used to enhance the sealing performance of the seal assembly 20 by preventing or reducing possible failures caused by elastomer extrusion. FIGS. 5-6 show the seal assembly 20 with the first backup member 46 and the second backup member 48 after the seal ring 30 is energized. It is understood that the backup members may be rings and made of a PEEK material, or any suitable shape and material that enhances anti-extrusion resistance. It is also understood that the second back up member is not necessary in the seal assembly for effective and efficient sealing performance. The seal assembly may provide a higher temperature and/or pressure rating as compared to currently used bonded seals made with similar materials.

The seal ring, the first energizing member, the second energizing member, the first backup member and the second backup member may be installed in a plurality of methods, such as using mechanical constraint, bonding, molding, etc.

FIGS. 3, 4 and 6 illustrate implementing the seal assembly 20 in a downhole application. In FIG. 3, the seal assembly 20 is installed into the bore 36; however, the seal ring 30 is not energized. The sleeve 38 is shifted in a right direction and held in position which maintains the axial load on the first energizing member 32 of the seal assembly 20. The seal ring 30 is then in an energized state because the seal ring is compressed between the first energizing member 32 and the second energizing member 34, and a seal is created and maintained between the seal ring 30 and the housing 24 (seal bore) and the seal ring 30 and the mandrel 26 (seal piston), as shown in FIG. 4. In FIG. 6, the seal assembly 20 is shown with the first backup member 46 and the second backup member 48 installed for preventing the extrusion of the seal ring 30.

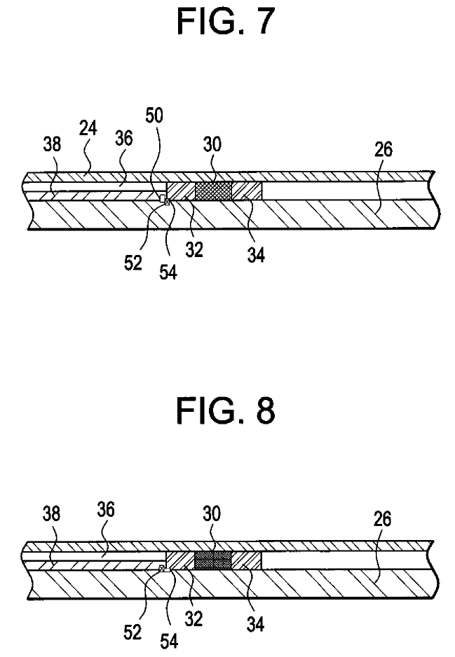

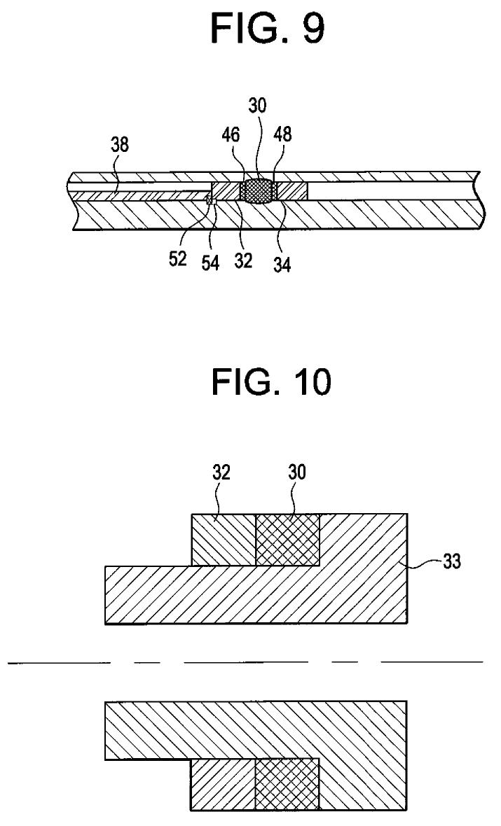

In FIGS. 7-9, a method for locking the seal assembly 20 in an energized position is shown. In FIG. 7, the sleeve 38 includes a first groove 50 for accepting a snap ring 52 which is held in place by in a second groove 54 in the mandrel 26 (seal piston). The grooves and snap ring locking mechanism are for locking the seal assembly 20 in the energized position. As described above, the seal assembly 20 may be installed into the bore 36; however the seal ring 30 is not energized yet, as shown in FIG. 7. When the sleeve 38 shifts to the right, the seal ring 30 is compressed and thereafter energized. After the first groove 50 in the sleeve 38 reaches the snap ring 52, the snap ring 52 moves or pops into the first groove 50, so that the seal ring 30 is held in the energized position, as shown in FIG. 8. The snap ring may be made of a metal material, or any suitable material that provides for an effective locking mechanism. As shown in FIG. 9, the seal assembly 20 may be locked in the energized position with the first backup member 46 and the second backup member 48 for preventing extrusion of the seal ring 30. It is understood that a variety of locking mechanisms may be used such as a groove and dog combination, and other locking mechanisms within the scope of the invention.

A releasing mechanism (not shown) may also be included for releasing the seal assembly from the energized position so that the seal ring may be de-energized for easy movement of the seal assembly in the bore or for re-stabbing the seal assembly in after being pulled out of the bore.

Other variations of seal assemblies are contemplated and are within the scope of the appended claims. The seal assemblies, which are disclosed herein may be used for numerous applications in the downhole environment, such as bridge plugs, straddles, retrofit locks, sliding sleeves, communications orifice & sleeves, liner hangers, permanent & retrievable packers, spool tree plugs, polished bore receptacle (PBR), seal assemblies, lateral windows & junctions, surface pressure control equipment, wireline stuffing boxes & grease injection heads, sub-sea riser, as just a few examples.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A seal assembly usable with a well, comprising:
a first energizing member;
a second energizing member; and
a seal ring adapted to expand radially inwardly and radially outwardly in response to being compressed between the first energizing member and the second energizing member.

2. The seal assembly of claim 1, further comprising:
at least one backup member, wherein the at least one backup member is between the seal ring and the first energizing member.

3. The seal assembly of claim 1, further comprising:
at least one backup member, wherein the at least one backup member is between the seal ring and the second energizing member.

4. The seal assembly of claim 1, further comprising:
a locking mechanism for maintaining the seal ring in an energized state.

5. The seal assembly of claim 1, wherein the locking mechanism comprises a snap ring.

6. The seal assembly of claim 1, further comprising:
a sleeve for compressing the first energizing member and the second energizing member so that the seal ring is maintained in an energized state.

7. The seal assembly of claim 1, wherein the first energizing member comprises a ring and the second energizing member is an end of a solid component.

8. A seal assembly usable with a well, comprising:
at least one energizing member to exert a compressive force; and
a seal ring adapted to expand radially inwardly and radially outwardly in response to the compressive force.

9. The seal assembly of claim 8, further comprising:
at least one backup member for preventing extrusion of the seal ring.

10. The seal assembly of claim 8, further comprising:
a locking mechanism for maintaining the seal ring in an energized state.

11. The seal assembly of claim 8, wherein the locking mechanism comprises a snap ring.

12. The seal assembly of claim 8, further comprising:
a sleeve for compressing the at least one energizing member so that the seal ring expands radially inwardly and radially outwardly.

13. The seal assembly of claim 8, further comprising:
a second energizing member, wherein the second energizing member comprises an end of a solid component.

14. A method usable with a well, comprising:
providing a seal ring to form a seal in the well when the seal ring is longitudinally compressed;
providing at least one energizing member for exerting a compressive force; and
exerting a compressive force against the at least one energizing member to compress the seal ring.

15. The seal assembly of claim 14, further comprising:
at least one backup member for preventing extrusion of the seal ring.

16. The seal assembly of claim 14, further comprising:
a locking mechanism for maintaining the seal ring in an energized state.

17. The seal assembly of claim 14, wherein the locking mechanism comprises a snap ring.

18. The seal assembly of claim 14, further comprising:
a sleeve for compressing the at least one energizing member so that the seal ring expands radially inwardly and radially outwardly.

19. The seal assembly of claim 14, further comprising:
providing a second energizing member, wherein the second energizing member comprises an end of a solid component.
